(19) United States
(12) Patent Application Publication
(10) Pub. No.: US 2018/0090749 A1
(43) Pub. Date: Mar. 29, 2018

(54) MAKING CHANNELED ELECTRODES FOR BATTERIES AND CAPACITORS

(71) Applicant: GM GLOBAL TECHNOLOGY OPERATIONS LLC, DETROIT, MI (US)

(72) Inventors: Zhiqiang Yu, Shanghai (CN); Haijing Liu, Shanghai (CN); Wentian Gu, Shanghai (CN)

(21) Appl. No.: 15/279,597

(22) Filed: Sep. 29, 2016

(51) Int. Cl. H01M 4/1391; H01M 10/0525; H01M 4/133; H01M 4/587; H01M 4/131; H01M 4/485; H01M 4/505; H01M 4/525; H01M 4/58; H01M 4/136; H01M 4/1393; H01M 4/1397; H01G 11/06; H01G 11/62; H01G 11/50; H01G 11/28; H01G 11/86; H01G 11/70; H01G 11/52; H01G 11/24

(52) U.S. Cl. CPC H01M 4/1391; H01M 2004/027; H01M 4/133; H01M 4/587; H01M 4/131; H01M 4/485; H01M 4/505; H01M 4/525; H01M 4/5825; H01M 4/136; H01M 4/1393; H01M 4/1397; H01G 11/06; H01G 11/62; H01G 11/50; H01G 11/28; H01G 11/86; H01G 11/70; H01G 11/52; H01G 11/24; H01M 10/0525

(57) ABSTRACT

The anode and/or the cathode of a lithium-transporting or sodium-transporting electrochemical battery cell or capacitor cell are formed of small (micrometer-size) electrode material particles having one or more channels extending through substantially each electrode particle. The through-channels are formed in the electrode particles as the particles are being formed from precursor materials. Channel-forming fibers are mixed with the electrode precursor materials when the electrode particles are being formed, and the channel forming material is removed from the formed electrode particles to leave through channels in the particles that may subsequently be infiltrated with an electrolyte for the cell.

### TECHNICAL FIELD

Particles of active electrode materials for lithium or sodium batteries or capacitors are formed with channels extending through their particulate shapes to increase their surface area and to further increase their contact area with the liquid electrolyte with which they are infused in the assembled battery or capacitor.

### BACKGROUND OF THE INVENTION

The material presented as background information in this section of the specification is not necessarily prior art.

There are several different types of batteries and capacitors under current development, and in use, which operate using a lithium ion-containing or sodium ion-containing liquid or solid electrolyte. Such batteries include lithium-ion batteries, sodium-ion batteries, lithium sulfur batteries, sodium sulfur batteries, lithium ion or sodium ion capacitors, and solid state batteries using lithium or sodium. In many of these electrochemical devices the electrode materials (i.e., the anode and cathode active materials) are prepared in the form of micrometer-size solid particles of a composition that will intercalate and de-intercalate lithium ions or sodium ions from and into a suitable electrolyte material.

For example, lithium-ion batteries are being adapted for applications in electrically powered automotive vehicles and in hybrid vehicles utilizing both an internal combustion engine and an electrical motor to power the vehicle. Other non-vehicle applications also utilize lithium or sodium batteries or capacitors of various combinations of electrode materials for providing electrical power.

In a common design of the cells of a lithium-ion battery (or a lithium-ion capacitor), the electrodes are formed of micrometer-size particles of active anode material or active cathode material bonded in a porous layer to one or both sides of a thin, electrically conductive metal foil. The metal foil serves as a current collector for the electrode material. In one group of battery structures, the electrodes are formed as relatively thin rectangular members. Like-sized anodes and cathodes are assembled alternately with a thin porous separator layer between each set of facing porous layers of particulate anode and cathode materials. The pores of each separator layer and each layer of electrode material are filled with an electrolyte solution of lithium salt(s) dissolved in a non-aqueous solvent. The DC potential of each cell is typically in the range of about two to four volts. The electrical current producing energy (Wh) of a cell depends largely on the compositions, shapes, and amounts of electrode materials that can be accommodated in the preparation and function of each electrode. There is a continuing need for electrode materials for lithium batteries and capacitors (and sodium batteries and capacitors) that can provide increased electric energy and power, and at lower costs.

### SUMMARY OF THE INVENTION

Practices of this invention are applicable to the making of channel-containing particulate electrode materials for lithium-ion batteries, sodium-ion batteries, lithium sulfur batteries, sodium sulfur batteries, lithium ion capacitors, and sodium ion capacitors, and solid state batteries utilizing lithium or sodium as an electrode and electrolyte constituent. But for purposes of illustration of specific examples, the practice of the invention will be described in detail in connection with the preparation of channel-containing particulate anode and cathode materials for use in a lithium-ion cells and batteries.

Selected compositions for the anode and cathode of a lithium-ion battery have typically been formulated in the shapes of individual solid particles having diameters or largest dimensions, for example, in the range of about 0.5 to 30 micrometers. The individual particles each present appreciable surface area with respect to their three-dimensional shapes for contact with a liquid lithium ion-containing electrolyte. A group of such particles are often mixed with a smaller portion of particles of a conductive material, such as carbon black or other conductive carbon particles, and bonded, e.g., with a relatively small quantity of a suitable polymeric binder material, as a porous particulate layer of generally uniform thickness to a flat major surface of a metal foil current collector. Alternating porous particulate layers of anode material and cathode material with an interposed thin porous layer of separator material are stacked or rolled to form cells of the lithium-ion battery. The layers of electrode materials and the intervening separator are infiltrated with a liquid lithium ion-conducting electrolyte, typically formed of a solution of a lithium salt in a non-aqueous solvent. The electrochemical efficiency of the cell or grouping of cells is dependent in part on good contact between lithium ions in the liquid electrolyte and the respective surfaces of the particles of anode material and particles of cathode material.

In accordance with practices of this invention, the particles of cathode material are initially formed with one or more channels extending through substantially each particle; each channel having an opening at one surface location and extending in a generally straight line to an opening at a second surface location. And the anode particles are also formed with comparable through-channels extending through substantially each of the anode particles. The contribution of such through-channels in each of the anode material particles and each of the cathode material particles is to increase the accessible contact area of each particle with the electrolyte liquid and to increase the transport of the electrolyte ions in the respective electrode particles and through the layers of the respective electrode particles.

The cathode of a lithium-ion cell is the positive electrode during discharge of the cell. Cathode particles for lithium-ion batteries are often composed of lithium-containing, one or more additional metal-containing, and oxygen-containing compounds such as lithium manganese oxide, lithium nickel oxide, lithium cobalt oxide, lithium cobalt aluminum oxide, lithium nickel manganese cobalt oxide, lithium iron phosphate, and other lithium-metal-oxides, and lithium-metal-phosphates. Many of these compounds are used commercially and prepared in substantial amounts. Procedures are known for synthesizing substantially all such compounds with useful crystal structures for the intercalation and de-intercalation of lithium (or sodium). Such lithium-containing compounds may be formed, for example, by dissolving selected precursor compounds in water and precipitating the small crystalline particles of the desired compound from the aqueous solution of precursors. In other practices, the lithium and oxygen containing cathode compound material may be formed by known sol-gel processes, or known hydrothermal/solvothermal processes. The lithium-containing cathode compound is formed or synthesized by a suitable, known method and then separated as a crystalline material from the liquid medium or other medium in which it was formed.

However, before the desired lithium-containing compound is precipitated (or otherwise formed in the solid state), a suitable amount of small (nanometer-size or lower micrometer size) channel-former fibers are dispersed in the aqueous solution or other reaction medium. Suitable channel-formers for the particles of lithium-containing cathode material include carbon fibers (with or without branches), carbon nanotubes, vapor grown carbon fibers (VGCF), carbon powder, polymer fibers, SiO₂ fibers, or metal or metal oxide fibers. Such channel-former materials suitably have lengths in the range of 100 nanometers to 10 micrometers and complementary smaller diameters in the range of ten nanometers to one micrometer. The surfaces of the channel-formers may be thinly coated with a surfactant to enhance dispersion of the fibers in the solution or other reaction medium from which the cathode compound is formed. Typically, precursor articles of the desired cathode material are formed on and around the channel-forming fibers such that the intended channel-forming fibers extend into the precursor particles or, preferably, into and through the precursor particles from one surface region to an opposing surface region. Calcination of the particles of precursor material leads to the formation of particles of the electrode material which still contain the channel-forming fibers. The calcination step may also promote removal of the fibers from the bodies of the formed electrode particles leaving channels extending through the particles, i.e., from one surface of the particle to an opposing surface. The channels are intended to subsequently accommodate a small fluid volume of liquid electrolyte.

Accordingly, in a specific example, particles of lithium manganese oxide, LiMn₂O₄ in spinel ionic crystal structure (LMO), or precursor materials for lithium manganese oxide, may be precipitated from an aqueous solution of lithium nitrate and manganese nitrate, for example by the addition of lithium hydroxide, onto small carbon fibers dispersed uniformly in the aqueous medium. In a preferred practice, each precipitated particle of lithium manganese oxide precursor (e.g., a deposit of lithium hydroxide and manganese hydroxide ((Mn(OH)₂), forms on one or more of the dispersed carbon fibers. The precipitated carbon fiber-containing LMO precursor particles are separated from the aqueous medium, washed if necessary, and dried. The dried LMO precursor particles are then heated in air (annealed) at a selected temperature (e.g., in the range of 500° C. to 1500° C. for the purpose of crystallizing LMO and oxidizing the entrained carbon fibers to carbon dioxide. Following the removal of the channel-forming carbon fibers as carbon dioxide, the LMO particles are now each characterized by the presence of one or more channels through their particulate shapes. The channel-containing LMO particles of cathode material are then suitable for use as the cathode material in a lithium-ion cell or battery of cells in which the electrode material is intended to be contacted by and to receive liquid electrolyte within its channel or channels.

The anode of a lithium-ion cell is the negative electrode when the cell is being discharged to produce a flow of electrons in an external resistive circuit. Channel-containing, anode particles may be prepared in a manner analogous to the above-described description of the preparation of cathode particles. Anode particles for lithium-ion cells and batteries (and capacitors) are often formed of graphite, other forms of carbon, or lithium titanate (Li₄Ti₅O₁₂). In the event that the selected anode material is lithium titanate particles, they may be prepared with through-channels in a practice utilizing carbon fibers like that described above in this specification for the preparation of LMO cathode particles. Graphite and other carbon anode materials are often prepared from a selected carbon precursor such as a carbon-based oil or pitch. In accordance with practices of this invention a selected volume or mass of carbon particle precursor is mixed with fiber-like particles of a metal, metal oxide, metal carbide, or of SiO₂. Such channel-forming fibers are preferably sized like the carbon fibers described in an above paragraph of this specification.

The volume of the mixture of carbon particle precursor and channel-forming fibers is heated in a known, presently-used reaction medium (such as an inert liquid medium) such that small individual particles or droplets of fiber-filled carbon particle precursor are melted and initially formed. The melted carbon precursor particles are heated to temperatures in the range of 1500° C. to 3000° C. and progressively carbonized while they continue to contain their channel-forming fibers. When suitable carbon anode particles have been formed by the carbonization reaction, the carbon particles are cooled and ready for removal of their entrained channel formers. In many embodiments of the invention, the metallic or silicon-containing channel-formers are readily leached from the carbon particles using an acid or other suitable solvent. Following the removal of the channel-forming fibers, the carbon particles are now each characterized by the presence of one or more channels through their particulate shapes. The channel-containing carbon particles of anode material are then suitable for use as the anode material in a lithium cell or battery of cells.

A suitable quantity of channeled cathode particles may be used in the preparation of a porous cathode layer for a lithium or sodium battery or capacitor and a suitable quantity of channeled anode particles may be used in the preparation of a complementary porous anode for a lithium or sodium battery or capacitor. Alternatively, a cell may be formed using channeled cathode particles in combination with conventional (non-channeled) anode particles or vice-versa.

Other objects, embodiments, and examples of the practice of this invention will be apparent from a detailed description of illustrative embodiments which follow in this specification.

### BRIEF DESCRIPTION OF THE DRAWINGS

FIG. 1 is an enlarged schematic illustration of a spaced-apart assembly of three solid members of a lithium-ion electrochemical cell. Small portions of the porous anode and cathode layers are broken out and enlarged to show the through-channels formed in the particles of anode material and the particles of cathode material. The through-channels in the particles of anode and cathode materials are illustrated schematically, and intended to show a few channels in each particle that extend from a surface region of the particle through the particle to another portion of the surface of the particle. The number of channels formed in an electrode particle depends on the practice of the process by which it is formed. The solid anode, opposing cathode, and interposed separator are shown spaced apart to better illustrate their structure. The drawing does not illustrate the electrolyte solution which would fill the pores of the electrode layers and the separator when those members are assembled in a pressed-together arrangement in an operating cell.

FIG. 2 is an enlarged, broken-out, schematic illustration of a porous layer of particles of cathode material with through-channels formed in the particles of cathode material and bonded to an aluminum foil current collector, and a porous layer of anode particles, each containing channels, and bonded to a copper current collector foil. Again, the through-channels in the particles of anode and cathode materials are illustrated schematically, and intended to show a few channels in each particle that extend from a surface region of the particle through the particle to another portion of the surface of the particle. The number of channels formed in an electrode particle depends on the practice of the process by which it is formed. The unbounded sides of the porous electrode layers are pressed against opposite sides of a co-extensive porous polymeric separator member.

FIG. 3 is a schematic cross-sectional side view of an anode current collector foil coated on both major sides with a mixture of active anode material particles with through-channels, a cathode current collector foil coated on both sides with a mixture of active cathode material channel-containing particles for a lithium-ion battery cathode. The two electrodes are rectangular in shape (not visible in this side view, but as illustrated in FIG. 1). The opposing major faces of the anode and cathode are physically separated by a porous rectangular polymer separator layer wound from the full outer surface of the cathode, around one edge of the cathode to fully cover the inner face of the cathode and separate it from the adjoining face of the anode, around the edge of the anode to cover the outer face of the anode. The two electrodes with their channel-containing particulate electrode materials are placed within a closely spaced pouch container. The pouch contains a non-aqueous electrolyte solution which permeates and fills the pores of the separator and of the respective active anode and cathode coating layers. The respective current collector foils have uncoated tabs extending up from their top sides and through the top surface of the pouch container.

### DESCRIPTION OF PREFERRED EMBODIMENTS

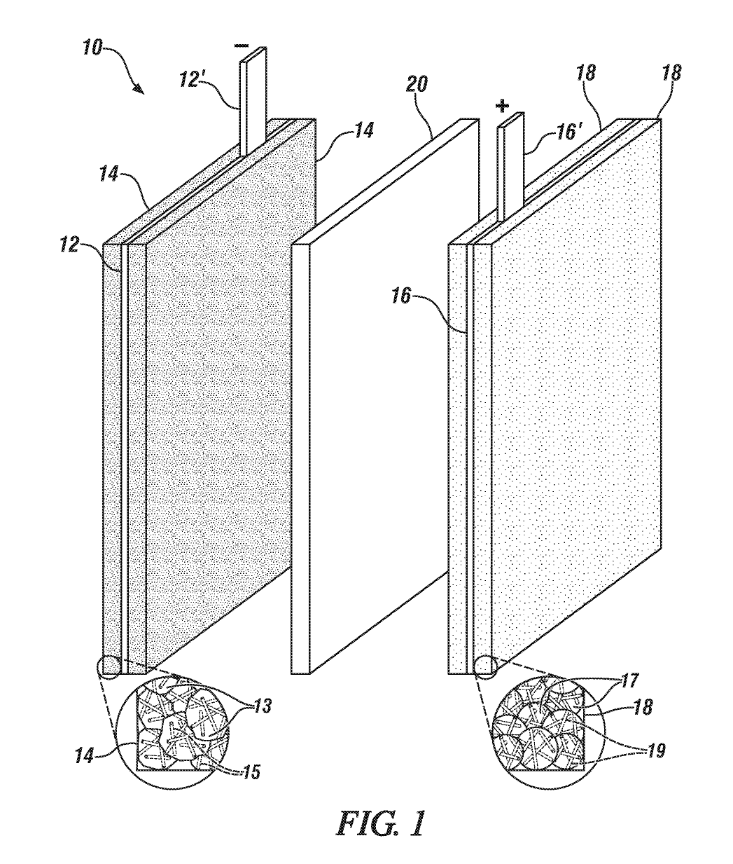

FIG. 1 is an enlarged schematic illustration of a spaced-apart assembly 10 of an anode, cathode, and separator of a lithium-ion electrochemical cell. The three solid members are spaced apart in this illustration to better show their structure. The illustration does not include an electrolyte solution whose composition and function will be described in more detail below in this specification.

In FIG. 1, the anode, the negative electrode during discharge of the cell, is formed of uniformly-thick, porous layers 14 of carbon (e.g., graphite) particles, the majority of the carbon particles being formed with through-channels, and deposited and resin bonded on both major surfaces of a relatively thin, conductive metal foil current collector 12. For example, the carbon anode particles, and any conductive carbon particles or other additives, may be resin-bonded, for example, to the current collector by preparing a slurry of the particles in a solution of polyvinylidene difluoride (PVDF) dispersed or dissolved in N-methyl-2-pyrrolidone and applying the slurry as a porous layer (a precursor of anode layer 14) to the surfaces of the current collector 12 and removing the solvent. When the anode is formed of channel-containing carbon particles, the negative electrode current collector 12 is typically formed of a thin layer of copper foil. The thickness of the metal foil current collector is suitably in the range of about ten to twenty-five micrometers. The current collector 12 has a desired two-dimensional plan-view shape for assembly with other solid members of a cell. Current collector 12 is illustrated as having a major surface with a rectangular shape, and further provided with a connector tab 12′ for connection with other electrodes in a grouping of lithium-ion cells to provide a desired electrical potential or electrical current flow.

As stated, deposited on both major faces of the negative electrode current collector 12 are thin, porous anode layers 14 of channel-containing carbon particles. In accordance with this disclosure, the negative electrode material is typically resin-bonded particles of channel-containing carbon particles which may include interspersed activated carbon particles providing enhanced electron conductivity. As illustrated in FIG. 1, the layers of anode material 14 are typically co-extensive in shape and area with the main surface of their current collector 12. In FIG. 1 a broken out portion of one of the anode layers 14 is enlarged to schematically illustrate individual carbon particles 13 with through-channels 15. In this broken out view only the channel-containing carbon particles are illustrated. No binder resin or conductive carbon particles are shown to simplify the illustration of the channel-containing 15, carbon anode particles 13.

The particulate electrode material has sufficient porosity to be infiltrated by a liquid, non-aqueous, lithium-ion containing electrolyte. In accordance with embodiments of this invention, the thickness of the rectangular layers of carbon-containing negative electrode material may be up to about two hundred micrometers so as to provide a desired current and power capacity for the anode.

A cathode is shown, comprising a collector foil 16 (which is positively charged during discharge of the cell) and on each major face, a coextensive, overlying, porous layer 18 of a resin-bonded mixture of particles of through channel-containing, active cathode material. For example, the selected cathode material may be particles of lithium manganese oxide (LiMn₂O₄, spinel structure), the majority of the LMO particles being formed with through channels in accordance with this invention. A broken-out portion of one of the layers 18 of active cathode material is enlarged to schematically illustrate particles of cathode material 17 with their through-channels 19. No binder resin or conductive particles are shown in this enlarged simplified illustration.

Positive current collector foil 16 may be formed of aluminum. Positive current collector foil 16 typically also has a connector tab 16′ for electrical connection with other electrodes in a grouping of like lithium-ion cells or with other electrodes in other cells that may be packaged together in the assembly of a lithium-ion battery. The cathode collector foil 16 and its opposing coated porous cathode material layers 18 of channel-containing LMO particles are typically formed in a size and shape that are complementary to the dimensions of an associated negative electrode.

In the illustration of FIG. 1, the two electrodes are substantially identical in their shapes and assembled in a lithium-ion cell with a major outer surface layer of the anode material 14 facing a major outer surface layer of the cathode material 18. The thicknesses of the rectangular layers of positive electrode material 18 are typically determined to complement the anode material 14 in producing the intended electrochemical capacity of the lithium-ion cell. The thicknesses of current collector foils are typically in the range of about 10 to 25 micrometers. And the thicknesses of the respective electrode material layers are typically up to about 200 micrometers.

A thin porous separator layer 20 is interposed between a major outer face of the negative electrode channel-containing particulate material layer 14 and a major outer face of the positive electrode channel-containing particulate material layer 18. A like separator layer 20 could also be placed against each of the opposite outer layers of negative electrode material 14 and the opposite outer layer of positive electrode material 18 if the illustrated individual cell assembly 10 is to be combined with like assemblies of cell members to form a battery with many cells, for example, many stacked or rolled cells.

In many battery constructions, the separator material is a porous layer of a polyolefin, such as polyethylene (PE) or polypropylene (PP). Often the thermoplastic material comprises inter-bonded, randomly oriented fibers of PE or PP. The fiber surfaces of the separator may be coated with particles of alumina, or other insulator material, to enhance the electrical resistance of the separator, while retaining the porosity of the separator layer for infiltration with liquid electrolyte and transport of lithium ions between the cell electrodes. The separator layer 20 is used to prevent direct electrical contact between the facing negative and positive electrode material layers 14, 18, and is shaped and sized to serve this function. In the assembly of the cell, the facing major faces of the channel-containing electrode material 14, 18 are pressed against the major area faces of the separator membrane 20. A liquid electrolyte is typically injected into the pores of the separator and electrode material layers.

The electrolyte for the lithium-ion cell is often a lithium salt dissolved in one or more organic liquid solvents. Examples of suitable salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide (LiTFSI). Some examples of solvents that may be used to dissolve the electrolyte salt include ethylene carbonate, dimethyl carbonate, methylethyl carbonate, and propylene carbonate. There are other lithium salts that may be used and other solvents. But a combination of lithium salt and solvent is selected for providing suitable mobility and transport of lithium ions in the operation of the cell. The electrolyte is carefully dispersed into and between closely spaced layers of the electrode elements and separator layers. In accordance with this invention, the electrolyte is also dispersed in the channels of the particles of the respective electrode materials. The electrolyte is not illustrated in the drawing figure, but it is schematically illustrated in FIG. 3.

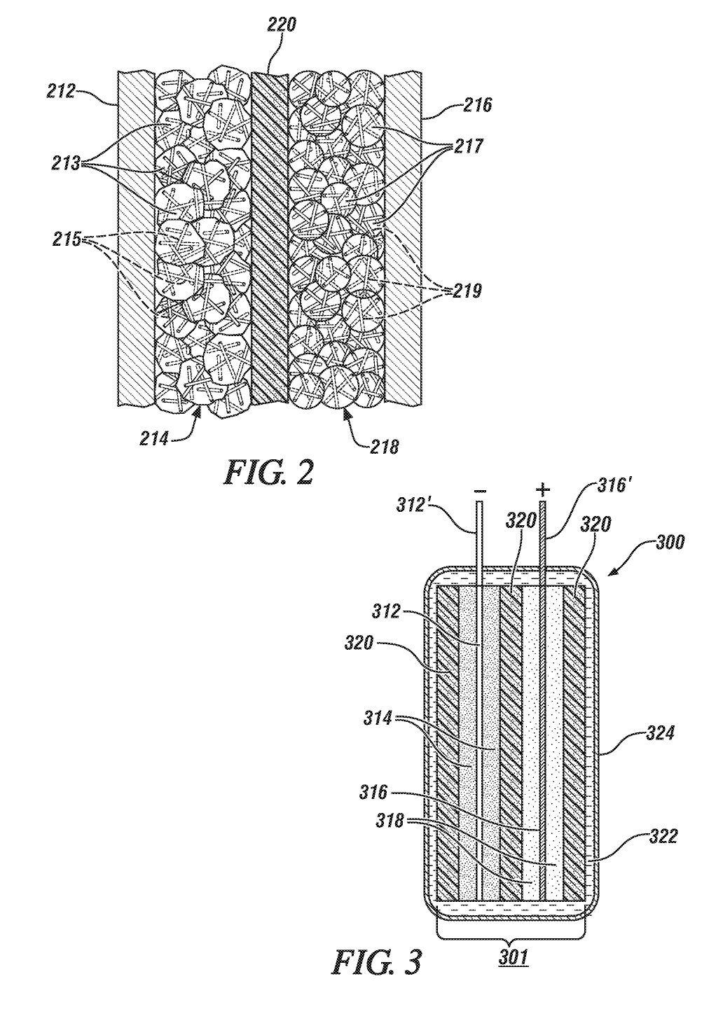

FIG. 2 is an enlarged schematic illustration of a porous anode layer 214 bonded one of its sides to one face of a copper current collector foil 212. The other major face of porous anode layer 214 is placed coextensively against one side of a porous, electrically insulating separator 220. Placed against the other face of separator 220 is one side of a porous cathode layer 218. The second side of porous cathode layer 218 is bonded to an aluminum current collector foil 216.

As illustrated schematically in FIG. 2, porous anode layer 214 comprises micrometer-size particles of active anode material 213. Each of the micrometer-size particles 213 (or at least a majority of the anode material particles) is formed with channels 215 preferably extending through their particulate bodies 213. As suggested above in this text, the particles of active anode material 213 may be formed of graphite or other suitable lithium-ion-intercalating form of carbon. Several other suitable anode materials are listed above in this specification. In FIG. 2, the particles of anode material 213 are illustrated as being somewhat spherical, but irregular in shape. The anode materials may have other shapes, but it is preferred that the particles be shaped for mixing and close packing while leaving suitable pore space for infiltration with the liquid electrolyte which is introduced into an assembled cell.

Porous cathode layer comprises a porous layer 218 of micrometer-size particles of active cathode material 217, formed to contain through-channels 219 and resin-bonded as a porous layer 218 to an aluminum current collector foil 216. As suggested above in this text, the particles of active cathode material 217 may be formed, for example, of LMO (lithium manganese oxide). Several other suitable cathode materials are listed above in this specification. In FIG. 2, the particles of channel-containing 219, cathode material 217 are also illustrated as being spherical. But the cathode materials may have other shapes suitable for mixing and close packing while leaving suitable pore space for infiltration with the liquid electrolyte which is introduced into an assembled cell.

FIG. 3 presents a simplified, schematic, cross-sectional side-view of an assembly 300 of a single cell 301 of lithium-ion battery electrode materials assembled into a polymer-coated, aluminum foil pouch 324. The cell 301 with electrode materials comprises a cathode current collector foil 316 coated on both major sides with a porous layer of active through-channel-containing cathode material particles 318 for a lithium-ion battery cathode. Cell 301 also comprises an anode current collector foil 312 coated on both sides with a porous layer of through channel-containing active anode material particles 314 for a lithium-ion battery anode. The two electrodes are rectangular in shape (like those illustrated in FIG. 1). The opposing major faces of the anode and cathode are physically separated by porous rectangular polymer separator layer 320 which in some embodiments may be wound from the full outer surface of the cathode, around one edge of the cathode to separate the adjoining face of the anode and the cathode, around the edge of the anode to cover the outer face of the anode. The two electrodes with their through channel-containing electrode materials are placed within a closely spaced pouch container 324. The pouch 324 contains a non-aqueous electrolyte solution 322 which permeates and fills the pores of the separator 320 and of the respective active anode and cathode coating layers 314, 318. The respective current collector foils 312, 316 have uncoated tabs 312′, 316′ extending up from their top sides and through the top surface of the pouch container 324.

At least one of the anode and cathode of each lithium-ion cell (or sodium cell or lithium or sodium capacitor), and preferably both, are formed by preparing channel-containing particles of suitable electrode material. In the preparation of a resin-bonded porous electrode layer, the individual channel-containing particles are coated or otherwise suitably combined with a suitable amount of a bonding material and in a manner such that the particles may be suitably bonded in a porous layer of electrode material without covering the through-channels in the electrode particles and losing the benefit of their presence in a cell or battery (or capacitor). For example, the channel-containing particles of active electrode material may be dispersed or slurried with a solution of a suitable resin, such as polyvinylidene difluoride dissolved in N-methyl-2-pyrrolidone, and spread and applied to a surface of a current collector in a porous layer. Other suitable binder resins include carboxymethyl cellulose/styrene butadiene rubber resins (CMC/SBR). The binders are not electrically conducive, which is a further reason that they should be used in a minimal suitable amount to obtain a durable coating of porous electrode material and without covering the channel openings in the surfaces of the particles of electrode material. After the bonding action or reaction is completed, a porous layer of electrode material particles is formed on the current collector. The electrode material particles (and conductive carbon particles or other additives) are bonded to each other as a porous layer, and one side of the layer is bonded to the current collector.

It is preferred that the porous layers of electrode materials have a generally uniformly distributed porosity and total pore volume produced by the pore spaces between the channel-containing particles of electrode material. Both the channels formed in the electrode material particles and the spaces between the particles contribute open volume for infusion with a liquid electrolyte. Such porosity and channels volume permits the electrode layers to be suitably generally uniformly infiltrated with a volume of suitable liquid electrolyte. The interaction of the combination of the volume of liquid electrolyte material and the channel-containing particles of electrode materials produce the desired functions of the electrodes. In most electrode structures, the total channel volume and pore volume is suitably in the range of about 15 to 50 percent of the superficial outline volume of the applied electrode layer.

As illustrated in FIG. 3, each anode layer 314 or cathode layer 318 has one surface bonded to its current collector 312, 316 and the other surface lies against an adjacent surface of a porous separator 320. The volume and nature of the total number of individual pores between the channel-containing particles of the electrode is to permit an inserted liquid electrolyte 322 to permeate the electrode layers 314, 318 from the separator side to the current collector side of the anode or cathode. Lithium ions must be accessible to the surfaces of the particles of the anode or cathode material and the channels formed within them.

As stated, in general, the method aspect of this invention provides active anode material particles with through-channels within the formed active anode particles and/or, separately, active cathode material particles with through-channels within the cathode material particles. Suitable precursor particles of a selected anode or cathode material are formed in a manner in which the precursor material(s) are deposited or otherwise formed around nanometer size or lower micrometer size fibers (or tubes or rods or the like) of a suitable composition. The fibers are initially sized so as to extend through the droplets or particles of precursor material which entrains them. The fibers are used as channel-formers with respect to the enclosing particulate or droplet precursor(s) of the electrode material. Small droplets or particles of the precursor material(s), with the enclosed fibers, are heated in an atmosphere suitable for converting the precursor material(s) into particles of the desired active electrode material. Concurrently with, or subsequently to, the formation of the active electrode material, the entrained, channel-forming fibers are chemically removed from within the particles of active electrode material. The majority or all of the active electrode material particles now contain one or more channels extending through some portion of the electrode particles. Thus, when the particles are formed as a porous electrode layer for a battery or capacitor, and then infiltrated with a liquid electrolyte, the electrolyte flows in the pores between the particles and in the channels within the particles.

It is recognized that there are many different chemical or material compositions of electrode materials for the lithium-using and sodium-using electrode materials used in such batteries and capacitors. Those electrode materials in present use have known manufacturing processes for utilizing precursor materials in the synthesis or preparing of the electrode materials in particle form for subsequent processing into porous particulate electrode layers. And newly identified electrode materials will have suitable methods for their preparation into usable particulate forms. The processes of this invention can use such known precursor processing in the formation of electrode particles with internal through-channels for increasing the surface areas of the particles for contact with a liquid electrolyte solution to be used in the assembled battery or capacitor.

Two illustrative examples follow in which the use of precursors to form channel-containing electrode materials for batteries or capacitors is presented.

In the above Summary portion of this specification, the preparation of channeled lithium manganese oxide particles as active cathode material particles and the preparation of channeled carbon particles as active anode particles, both for lithium-ion battery cells, are described. Following are further descriptions of these processes utilizing known precursor materials for each electrode material.

First, channel-containing lithium manganese oxide particles may be prepared as follows. An aqueous solution of manganese nitrate (Mn(NO₃)₂) and a hydrogen peroxide (H₂O₂)-based solution of LiOH are prepared and mixed. Vapor grown carbon fibers (VGCF) are dispersed in the mixed solution. The mixture is then heated in a sealed (but shaken) hydrothermal reactor at 110° C. to 180° C. over a period of eight to forty-eight hours. During this pressurized heating process, small particles of crystallized LiMn₂O₄ (LMO) are formed and precipitated on the VGCF fibers. At the completion of the reaction, the micrometer-size LMO particles with their entrained carbon fibers are separated from the aqueous medium and dried.

The LMO particles with their entrained carbon fibers are then calcined in air at 500-600° C. for the purpose of progressively oxidizing the entrained carbon fibers to carbon dioxide to achieve complete removal of the carbon fibers from the LMO particles. At the completion of the calcining step and with cooling of the particles, the LMO particles are found to have one or more channels distributed through their particulate shapes.

Second, channeled carbon particles of anode material may be prepared as follows. Petroleum coke or pitch, may be used as the precursor material for the production of the channeled carbon particles as active anode material. Petroleum coke or pitch contains approximately 10-20% volatile components in the form of water and volatile organic matter. Before this carbon precursor is suitable for the manufacture of synthetic carbon, its volatile components must be removed by a calcining process, which involves heating the coke or pitch to a high enough temperature (1250-1350° C.) to volatize, vaporize, or burn off any volatile components. Once the calcining process is completed the calcined and melted petroleum coke or pitch is be mixed with suitable, commercially available, micrometer-size fibers or elongated particles of a metal oxide or silicon-containing channel-former (such as Al₂O₃ or SiO₂). The mixture of hot molten pitch and oxide fibers is suitably kneaded and shaped into small droplets.

After the kneading and shape-forming, the fiber-filled carbon precursor mixture is heated to a temperature higher than about 2800° C. and progressively carbonized while the droplets or particles continue to contain their channel-forming fibers. The high temperature carbonization process produces a reducing atmosphere. During the carbonization process, the channel-forming fibers are partially reduced to Al or silicon in the reduction atmosphere. Finally, the resulting carbon particles are cooled and ready for removal of their entrained channel formers by hydrochloric acid or hydrofluoric acid. Following the removal of the channel-forming fibers, the carbon particles are now each characterized by the presence of one or more channels through their particulate shapes. The channel-containing carbon fibers are suitable for use in a range of lithium-using or sodium-using batteries and capacitors.

Thus, available precursor materials for many known anode and cathode materials may be adapted for deposition of the precursor(s) as small bodies (including liquid or semi-liquid bodies) on channel-forming fibers. Upon suitable heating, particles of the electrode composition are formed on the channel-forming fibers (or like shapes). The entrained channel-forming fibers are removed from their surrounding particles of electrode material to leave one or more channels extending into or into and through the body portions of the majority of the electrode particles. And the channel-containing electrode particles may be utilized in a wide range of lithium-using or sodium-using battery cells or capacitor cells. As stated, when the channel-containing electrode particles are immersed in a compatible liquid electrolyte for the electrolytic cell, the electrolyte is able to contact both external surfaces and channel surfaces of electrode particles and increase effectiveness of the absorption and de-absorption of the lithium or sodium into and from the electrolyte particles.

The illustration of practices of the subject invention is not intended to limit or define the proper scope of the invention.

1. A battery or capacitor comprising:
an anode formed of particles of a lithium-containing or sodium-containing active anode material, a cathode formed of particles of a lithium-containing or sodium-containing active cathode material, and a liquid electrolyte containing lithium ions or sodium ions that interact electrochemically with the anode and cathode materials in the operation of the battery or capacitor;
the particles of at least one of the active anode material and the active cathode material containing channels that extend into the particles of electrode material, or into and through the particles of electrode material, the channels in the particles of electrode material being sized to receive a portion of the liquid electrolyte within the interior of the particles in the electrochemical operation of the battery or capacitor.

2. A battery or capacitor as stated in claim 1 in which channel-containing particles of electrode material have largest dimensions in the range of 0.5 to 30 micrometers.

3. A battery or capacitor as stated in claim 1 in which both the active anode material particles and the active cathode material particles contain channels that extend through their particles.

4. A battery or capacitor as stated in claim 1 which is composed as a lithium-ion battery and in which both the active anode material particles and the active cathode material particles contain channels that extend through the particles of the electrode materials.

5. A battery as stated in claim 4 in which the particles of active anode material are composed of carbon particles with channels extending through the carbon particles or particles of lithium titanate with channels extending through the lithium titanate particles.

6. A battery as stated in claim 4 in which the particles of active cathode material are formed of particles of a lithium-containing, additional metal-containing, and an oxygen-containing compound with channels extending through the particles.

7. A battery as stated in claim 6 in which particles of active cathode material are formed of at least one of lithium manganese oxide, lithium nickel oxide, lithium cobalt oxide, lithium cobalt aluminum oxide, lithium nickel manganese cobalt oxide, and lithium iron phosphate.

8. A battery as stated in claim 6 in which particles of active cathode material are formed of an ionic crystalline compound of a lithium-metal-oxide in which the metal is one or more of the elements selected from the group consisting of aluminum, cobalt, iron, manganese, and nickel.

9. A battery as stated in claim 1 comprising particles of an active cathode material for the battery, the particles of active cathode material having a largest dimension of about thirty micrometers and the particles of active cathode material having channels extending through the particles of active cathode material.

10. A battery as stated in claim 1 comprising particles of an active anode material for the battery, the particles of active anode material being carbon particles having a largest dimension of about thirty micrometers and the carbon particles of the active anode material having channels extending through them.

11. A method of making particles of active cathode material or of active anode material for a battery or capacitor, the as-made particles of active cathode material or of active anode material having one or more internal channels for receiving a volume of liquid electrolyte in a battery or capacitor in which the channel-containing particles of electrode material are used; the method comprising:
dissolving or dispersing a precursor composition of the active electrode material in a volume of a liquid;
dispersing fibers in and throughout the volume of the liquid, the fibers being non-reactive with the precursor composition;
forming particles of the precursor of the active electrode material composition such that at least a majority of the particles are formed around at least one of the dispersed channel-forming fibers and entrain at least one of the channel-forming fibers;
calcining the particles with their entrained channel forming particles to form particles of the desired active electrode material with entrained channel-forming fibers; and
subjecting the formed particles of active electrode material with their entrained channel-forming fibers to chemical and/or thermal processing so as to remove the entrained fibers from the particles of active electrode material to thereby leave one or more channels in each particle of active electrode material for subsequently receiving the liquid electrolyte.

12. A method as stated in claim 11 in which the formed channel-containing particles of active cathode material or of active anode material have maximum particle dimensions of up to about thirty micrometers.

13. A method as stated in claim 11 which comprises:
dispersing precursor compounds for a lithium-metal-oxide cathode material in water and mixing the aqueous dispersion with carbon fibers;
heating the water-containing mixture in a sealed container to form particles of the lithium-metal-oxide cathode material with entrained carbon fibers extending into, or into and through, the formed particles; and, thereafter
removing the entrained carbon fibers from the particles of lithium-metal-oxide cathode material to form the one or more channels in each particle for subsequently receiving the liquid electrolyte.

14. A method as stated in claim 11 which comprises:
mixing particles of a carbon-forming precursor with channel-forming fiber or fiber-like particles of a metal, silicon, a metal oxide, or silicon oxide such that carbon-forming precursor particles entrain the channel-forming particles, the carbon-forming precursor being carbonizable to form carbon anode material particles having maximum particle dimensions up to thirty micrometers;
heating the mixture to carbonize the carbon-forming precursor particles into carbon anode material particles which entrain the channel-forming particles; and
removing the channel-forming particles from the carbon anode material particles to form one or more channels in each carbon particle for subsequently receiving the liquid electrolyte.

15. A lithium-ion battery or capacitor comprising:
an anode formed of particles of an active anode material composed to receive lithium from a lithium-containing electrolyte, a cathode formed of particles of a lithium-containing active cathode material, and a liquid electrolyte containing lithium ions;
the particles of active anode material and/or particles of active cathode material containing channels that extend into the particles of the electrode material, or into and through the particles of the electrode material, the channels in the particles of electrode material being sized to receive liquid electrolyte within the interior of the particles in the electrochemical operation of the lithium-ion battery or capacitor.

16. A lithium-ion battery or capacitor as stated in claim 15 in which the channel-containing particles of electrode material have largest dimensions in the range of 0.5 to 30 micrometers.

17. A battery or capacitor as stated in claim 15 in which the active anode material particles and the active cathode material particles contain channels extending through the particles of the electrode materials.

18. A battery as stated in claim 15 in which the particles of active anode material are composed of carbon particles with channels extending through the carbon particles or particles of lithium titanate with channels extending through the lithium titanate particles.

19. A battery as stated in claim 19 in which the particles of active cathode material are formed of a lithium-containing, an additional metal-containing, and an oxygen-containing compound.

20. A battery as stated in claim 15 in which particles of active cathode material are formed of at least one of lithium manganese oxide, lithium nickel oxide, lithium cobalt oxide, lithium cobalt aluminum oxide, lithium nickel manganese cobalt oxide, and lithium iron phosphate.
